(19) United States
(12) Patent Application Publication
(10) Pub. No.: US 2011/0215614 A1
(43) Pub. Date: Sep. 8, 2011

(54) Lightweight cross-car beam and method of constructing a structural member

(76) Inventor: Ayyakannu Mani, Rochester Hills, MI (US)

(21) Appl. No.: 12/932,338

(22) Filed: Feb. 23, 2011

Related U.S. Application Data
(60) Provisional application No. 61/338,963, filed on Feb. 25, 2010.

(51) Int. Cl. B62D 25/00; B23P 15/00

(52) U.S. Cl. 296/193.02; 29/897.2

(57) ABSTRACT

A cross car beam or other elongated structural member including a series of walled open ended sections fixed end to end in a linear array by having ends joined to respective sides of a series of interposed junction plates. The junction plates may have locator features formed thereon to properly position the respective ends of adjacent sections and to be located in a welding fixture.

### CROSS REFERENCE TO RELATED APPLICATIONS

This application claims the benefit of U.S. provisional application No. 61/338,963 filed on Feb. 25, 2010, which is hereby incorporated by reference.

### BACKGROUND OF THE INVENTION

There is a considerable on-going effort to reduce the weight of automobiles in order to improve fuel economy and performance. This includes the various structural elements of the automobile body.

This effort includes substitution of lighter materials such as aluminum and magnesium for conventionally used steel.

Another always crucial consideration is cost (both in tooling and production), particularly in times of industry financial stress.

Magnesium is the lightest metal potentially useable for this application but is relatively expensive and has other problems limiting its use such that it no longer is considered a serious contender, leaving aluminum as the best choice.

A key major structural component is the cross car beam which is the backbone of the instrument panel in an automobile. This beam extends laterally between the “A” pillars to provide support for various diverse components located at the front end of the passenger compartment, i.e., the steering column, passenger airbag, entertainment/information modules, electronic accessories, and heating and cooling ducting components. Typically various component mounting brackets or supports are provided for the components to be mounted to the cross car beam.

Such cross car beams have in the past been constructed of formed steel with various mounting support features attached as by welding or with fasteners.

The trend to reduced weight construction of automobiles has led to attempts to use high pressure die cast aluminum or magnesium for the cross car beam, but these are normally more expensive than steel and not sufficiently lighter to warrant the higher cost.

It is an object of the present invention to provide a cross car beam constructed of a light weight material such as aluminum and a method of constructing such a structural member.

### SUMMARY OF THE INVENTION

The recited object and other objects which can be understood upon a reading of the following specification and claims are achieved by the present invention, in which a series of varying configuration thin walled sections which are separately formed as by extruding, casting, or other process are joined together to form the cross car beam.

The series of sections are secured together end to end in a linear array by being attached to respective opposite sides of interposed junction plates disposed between respective ends of adjacent sections as by welding or adhesively bonding.

The junction plates provide transition pieces for connecting the different end shapes of adjacent diverse sections and which also strengthen and stiffen the individual sections to improve the torsional and bending stiffness and strength of the resultant cross car beam. As noted, the sections are formed of thin wall hollow or open sided extrusions, castings or other pieces of different configurations each optimally shaped and located to hold a component to be mounted thereto.

The handling and welding and/or adhesive bonding steps are preferably performed by suitably programmed robots, such that high quality joints may be achieved at modest cost. The aggregate tooling costs for individual sections is less than the total tooling cost of a convention cross car beam total since the individual sections are smaller than the complete cross car beam and tooling for making extensions is much cheaper, comparatively.

A lightweight cross car beam according to the invention thus is provided at a reasonable cost.

Other structural members can be constructed by the method of joining a series of preformed sections end to end with junction plates according to the invention.

### DESCRIPTION OF THE DRAWINGS

FIG. 1 is a pictorial view of a typical prior art steel cross car beam.

FIG. 2 is a diagrammatic pictorial view of a cross car beam or other structure according to the present invention.

FIG. 3 is a fragmentary pictorial representation of a simplified segment of a cross car beam according to the invention showing diversely shaped sections joined together.

FIGS. 4 and 4A are pictorial views of respective opposite sides of a junction plate to be incorporated into a cross car beam according to the invention formed with locator features on each side for positioning respective adjacent ends of sections to be joined thereto and to be located in a welding fixture.

FIG. 5 is a pictorial view of a cross car beam constructed in accordance with the present invention together with fragmentary portions of an automobile body shown in broken lines.

FIG. 5A is a reverse pictorial view of the cross car beam shown in FIG. 5 slightly rotated upwards for clarity.

FIG. 6 is a fragmentary enlarged pictorial view of a portion of a cross car beam constructed in accordance with the method of the invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to FIG. 1, a traditional cross car beam 10 comprises a heavy gauge steel structure formed by a pair of stampings 12A,12B and a tubular end piece 14 all welded together. The structure cannot be a straight member and must be angled due to typical space restrictions imposed by the design of a car body and the need to support various components at different locations. Separate support brackets and elements are attached as by welding to allow mounting of various supported components such as the steering column, etc.

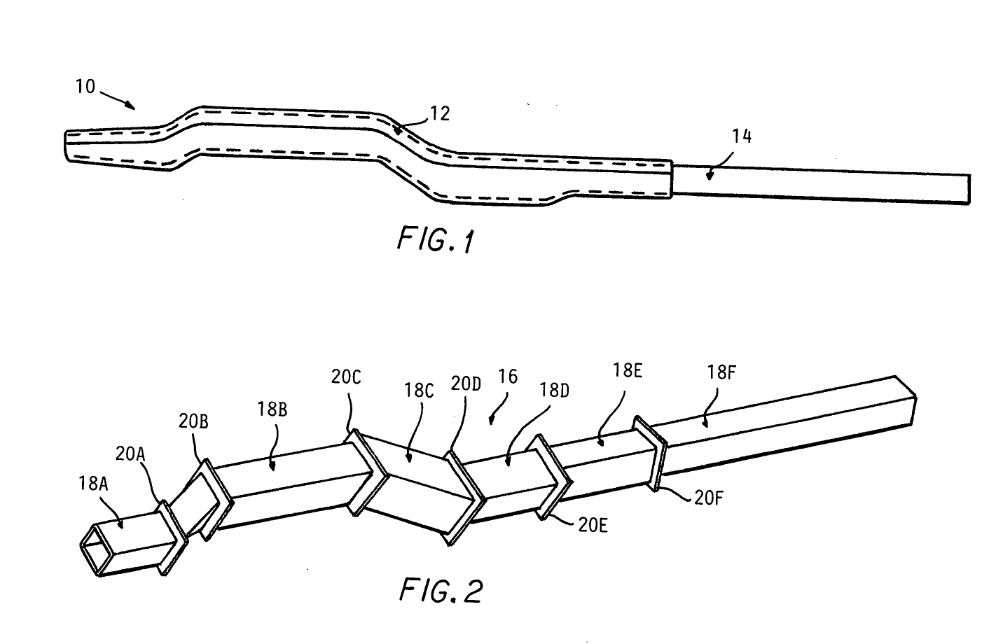

According to the present invention, a cross car beam 16 shown in FIG. 2 or other member is formed by attaching together a series of separately formed and differently configured individual thin walled sections 18A, 18B, 18C, 18D, 18E, 18F, extruded or cast preferably from aluminum. Other processes such as stamping may be used to form the section.

Each of the sections 18A-18F are attached together in an end to end linear array with a respective intermediate junction plates 20A, 20B, 20C, 20D, 20E, 20F interposed and abutting adjacent ends thereof as shown.

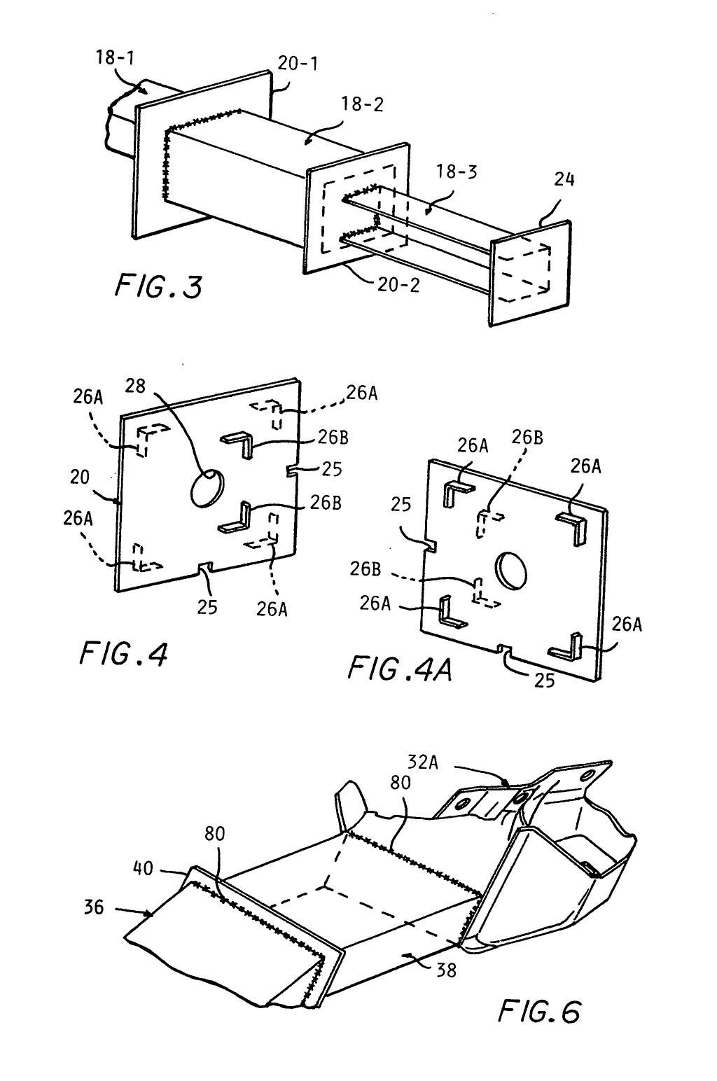

As indicated in FIG. 3, the adjacent ends of sections 18-1, 18-2 and 18-2, 18-3 are welded along their lines of contact 22 defined by the perimeter of the open wall ending of each section with an abutting respective side of intermediate junction plates 20-1, 20-2.

An end plate 24 can also be welded to a free end of an end section 18 for reinforcement and stiffening of the section 18. This is preferably and economically carried out by robotic welders which are very efficient when used for such purposes.

Similarly, an adhesive bonding robotic operation may alternatively be used to fix the ends to the junction plates 20.

FIGS. 4 and 4A illustrate that one or more of the plates 20 preferably have opposite sides formed with sets of locating features 26A, 26B, each receiving the respective end of an abutting section 18 in order to locate the same in readiness for welding or bonding together.

One or more lightening holes 28 may also be cut into the plates 20 as appropriate.

In addition, notches 25 or other features may be provided for location of the plates 18 on welding fixtures.

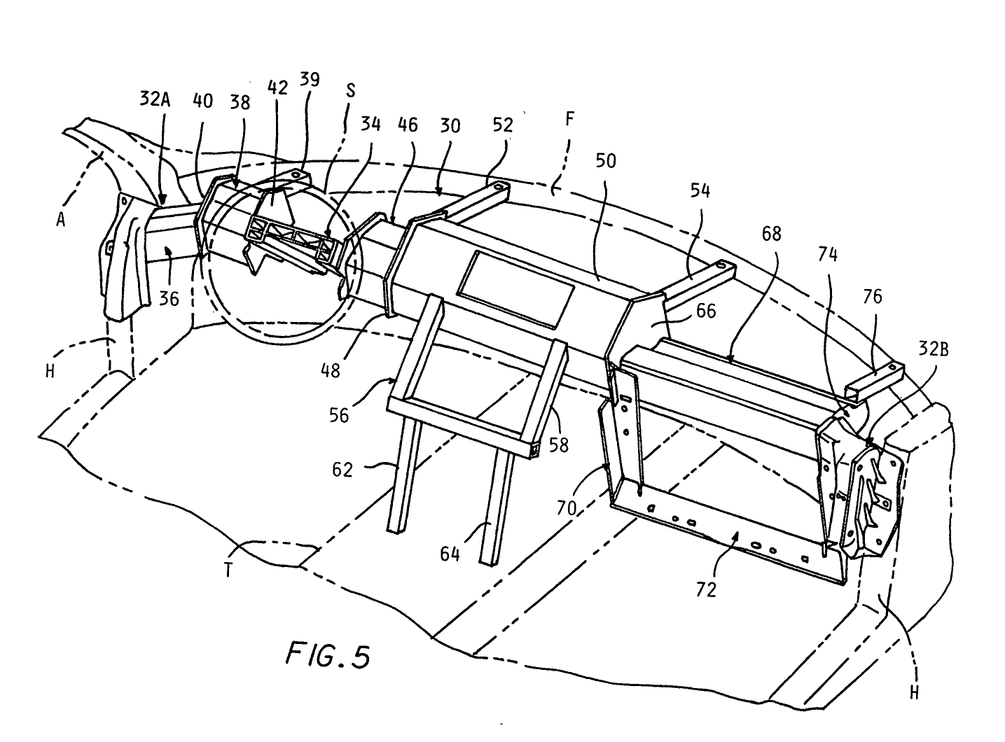

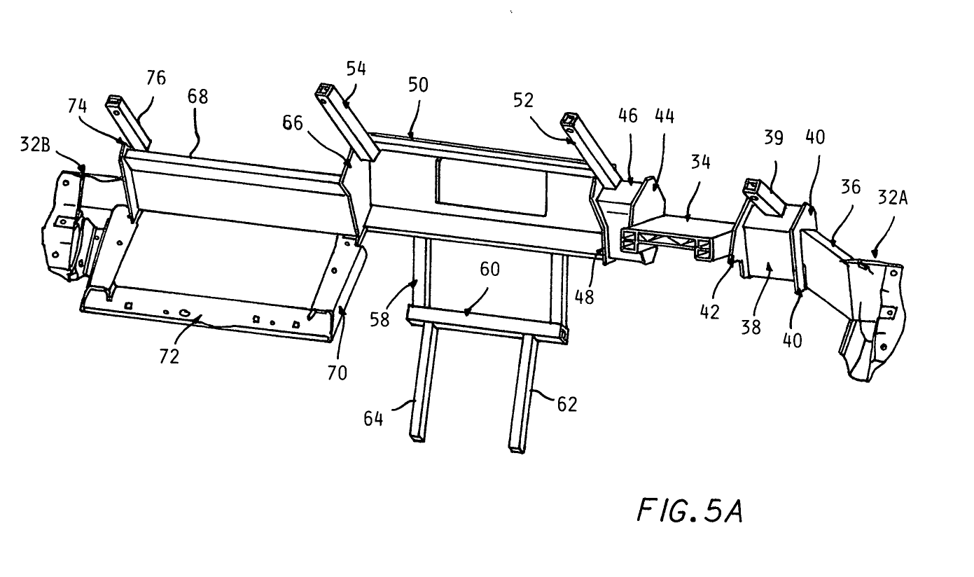

FIGS. 5 and 5A depict a typical cross car beam 30 having diverse separately formed sections joined together in an end to end aligned linear array to form a unitary beam, each section optimally configured to provide mounting support for various components such as the steering column, radio/CD player, glove box and connections to the A pillars A and hinge posts H.

The outboard A pillar connections can be provided by cast sections 32A, 32B.

A steering column extruded support platform 34 is connected to the left A pillar casting 32A with hollow box connector extrusions 36, 38. A support box extrusion 39 can be welded to the fire wall F.

A junction plate 40 connects the extrusion 36 to extrusion 38 welded to their juxtaposed ends.

A second junction plate 42 connects extrusion 38 to extruded platform 34.

A junction plate 44 is welded to the opposite end of the platform 34, and also to a hollow box connector extrusion 46.

The connector extrusion 46 also has a junction plate 48 welded to its opposite end attached to one end of a panel extrusion 50.

One end of the panel extrusion 50 is supported by a forwardly extending hollow square tube extruded strut 52 welded to the extrusion 46 and plate 48, while a second forwardly extending extruded hollow square tube strut 54 is welded to the panel extrusion 50.

A lower support for the panel extrusion 50 is provided by a weldment formed by square tubular extrusions 56, 58, 60, 62, 64, extrusions 56, 58 welded to the lower front face of the panel extrusion 50, extrusions 62, 64 welded to the floor plan tunnel T.

The right end of the panel extrusion 50 is welded to a junction plate 56, which has its opposite face welded to the left end of a glove box frame extrusion 68.

A glove box frame is completed by elongated low pressure castings 70, 72 and by the right A pillar connection casting 32B, which is also connected to the right end of the glove box frame extrusion 68 by being welded to a junction plate 74.

A horizontal support square tube extrusion 76 is welded to junction plate 74 and extrusion 68.

The welded or bonded connections 80 as seen in FIG. 6 can advantageously be carried out by a robot welder quickly and at low cost.

Thus, a unitary lightweight cross car beam can be provided with sections located and optimally configured to mount and support the various components, which provides a strong structural member for achieving an enhanced structural integrity of the automobile body.

This method can also be applied to construct such other complex structural members such as seat frames in automobiles, etc.

1. A cross car beam adapted to be attached at either end to an automobile body extending across said automobile body comprising:
a series of thin walled separate sections having different configurations, said sections having ends connected together end to end in an aligned linear array comprising said cross car beam, with junction plates interposed between each adjacent respective open ends of adjacent sections and fixed with said junction plates to respective section ends abutting a respective side of each of said junction plates to thereby connect all of said adjacent sections together.

2. The cross car beam according to claim 1 wherein said series of sections include one or more sections comprising extrusions.

3. The cross car beam according to claim 1 wherein said series of sections include one or more sections comprising castings.

4. The cross car beam according to claim 2 wherein said series of sections include one or more sections comprising castings.

5. The cross car beam according to claim 1 wherein said sections are each formed of aluminum.

6. The cross car beam according to claim 5 wherein said section ends are welded to respective sides of interposed junction plates.

7. The cross car beam according to claim 6 wherein one or more of said junction plates are formed with locator features on opposite sides thereof fit to a respective section end contour to thereby locate each section on a side of junction plate.

8. The cross car beam according to claim 7 wherein one or more of said junction plates are formed with fixture locating features to be able to be located in position for welding said section ends thereto.

9. A method of constructing a cross car beam comprising:
forming a series of diversely configured walled sections;
connecting an open end of each of said sections end to end together in a linear array, respective adjacent sections fixed to respective sides of corresponding interposed junction plates to form a unitary elongated structure comprising said cross car beam, with sections thereby positioned to mount a respective interior component.

10. The method according to claim 9 including forming one or more of said walled sections by extrusion.

11. The method according to claim 9 including forming one or more of said walled sections by casting.

12. The method according to claim 10 including forming one or more of said wall sections by casting.

13. The method according to claim 9 wherein said section ends are each attached to a respective one of a respective side of said interposed junction plates by welding.

14. The method according to claim 12 wherein said sections are formed of aluminum.

15. The method according to claim 9 including forming locator features on opposite side of junction plates engaging respective ends of said adjacent sections to locate the same.

16. A method of constructing a structural member comprising:
forming a series of walled sections;
attaching an open end of each section to a respective side of a series of junction plates each interposed between two adjacent sections to form a unitary structure comprised of said series of sections extending end to end in said series.
